(19) United States
(12) Patent Application Publication
(10) Pub. No.: US 2013/0002049 A1
(43) Pub. Date: Jan. 3, 2013

(54) BATTERY BOOSTER FOR AN ELECTRONIC DEVICE

(76) Inventor: URS STAMPFLI, WESTON, FL (US)

(21) Appl. No.: 13/540,044

(22) Filed: Jul. 2, 2012

Related U.S. Application Data
(60) Provisional application No. 61/503,775, filed on Jul. 1, 2011.

(51) Int. Cl. H02J 7/00; H01R 43/00

(52) U.S. Cl. 307/150; 29/825

(57) ABSTRACT

A battery booster for smartphones, tablets and other portable electronic devices is provided. The battery booster includes includes a battery pack and a retractable cable. A connector, structured to be electrically connected to the battery charging interface of a smartphone, is provided at one end of the cable. A securing mechanism is provided to removably secure a rear surface of the battery housing to the smartphone.

### CROSS-REFERENCE TO RELATED APPLICATIONS

The present application claims priority to: co-pending Provisional Patent Application No. 61/503,775, filed on Jul. 1, 2011, entitled “Battery Booster For An Electronic Device”; that application being incorporated herein, by reference, in its entirety.

### BACKGROUND OF THE INVENTION

1. Field of the Invention

The present invention relates to a power source for a portable electronic device and, more particularly, to a battery booster for a smartphone, tablet or other portable electronic devices.

2. Description of the Related Art

As technology has evolved over the past several years, the processing capabilities, features and functionality of smartphones, tablets (i.e., the iPad, Kindle, Nook, etc.) and other portable electronic devices and the usage of such electronic devices by people have increased greatly. As a result, people today rely heavily on portable electronic devices for many facets of their personal and business lives.

Whereas, cellphones were traditionally used predominantly to make phone calls, today's smartphones allow users to also, among other things, access the internet and download content, play and record music, record still and video images, review and prepare documents and send and receive texts, images, video clips and e-mails. Similarly, tablets today allow users to access the internet and, among other things, download and read newspapers and books, access and send e-mail, download and play games, prepare documents, conduct video conferences and perform other functions previously requiring a computer. The increased functionality of smartphones and tablets has changed the way people live their lives, interact and conduct business and has become an invaluable tool for many people.

Smartphones and tablets, like other portable electronic devices, are powered by batteries. As the functionality of these devices has increased, the drain on the device's battery has also increased. As people rely more and more on these devices to conduct their daily activities, battery life has become a very important concern.

When people are near an electrical outlet or in a car, they are able to charge the device's battery. However, when people are traveling or on the go, they are usually unable to charge the battery. Additionally, if they don't have the battery charger with them, they can't charge the battery. Once the battery is completely drained, the device will shut off and the person will lose all capabilities for which he or she relied on the device.

To address the battery life issue, people will often carry a backup battery or a battery booster with them. One issue that arises is that the backup battery or battery booster must be carried separately, which can be cumbersome and inconvenient, and the user must remember where he or she stored the backup battery or battery booster when they need to replace or recharge the first battery. If the user is using a backup battery, another issue that arises is that to replace the first battery with the backup battery, the user typically must remove the battery compartment cover, if possible, remove the first battery, replace it with the backup battery and replace the battery compartment cover. Depending on the circumstances, this is not always a convenient process for the user. For instance, if the user is in a location or situation where partially disassembling the device is difficult (i.e., in a car), the user might have to wait for a while before replacing the battery. During this period, the user will be unable to use the device. In addition, during the replacement process, the device will shut off and the user will lose whatever information was being accessed or utilized prior to it shutting off.

Likewise, the battery boosters currently available have many of the same problems as the backup battery. Specifically, hooking up the battery booster may not always be possible depending on where the user is (i.e., driving a car) and initiating the battery boost may not be possible until after the smartphone has shut off, resulting in information and data being lost or unavailable for a period of time. Additionally, battery boosters available today are designed to be held separate from the smartphone when in use. Consequently, they are difficult to handle when in use. Also, battery boosters currently available today use separate USB cables to connect the battery booster to the smartphone. When connected to the device, there is a portion of the cable extending between the battery booster and the smartphone that hangs and, if caught on other objects, can get damaged or disconnected from the smartphone or can cause the smartphone to fall to the floor. Additionally, the USB cable used by these prior art devices are completely detachable from the battery boosters and, as a result, if the user does not carry this cable at all times, they may be unable to use the battery booster when they need it.

Accordingly, there is a need in the art for a new and improved battery booster that charges the battery within a smartphone, tablet or other portable electronic device. Any such device should allow the user to continue to utilize the portable electronic device without interruption throughout the extended battery life without any loss of information or data. Such device should also be securable to the smartphone to make it easier to handle when in operation and to transport than battery boosters currently available. Such device should also include a retractable cable so that it is available for use with the device at all times and to reduce the hanging cable issues associated with the prior art battery boosters. The present invention is particularly suited to overcome those problems which remain in the art in a manner not previously known.

### SUMMARY OF THE INVENTION

The present invention is directed towards a new and improved battery booster for smartphones, tablets and other portable electronic devices. The battery booster includes a battery pack and a built-in retractable cable. A connector, structured to be electrically connected to the battery charging interface of a smartphone, is provided at one end of the cable. A securing mechanism is provided to removably secure a rear surface of the battery housing to the smartphone.

In one particular embodiment, a recessed cavity accessible from the outer surface of the battery housing is structured to secure the mating end of the connector when the connector is not electrically connected to the smartphone. Additionally, an adhesive pad on the rear surface of the battery housing is used to removably secure the battery housing to the smartphone. In another embodiment, a removable cover is attachable to the battery housing to cover the adhesive pad when the battery booster is not secured to the smartphone or to the opposite side of the battery housing when the battery booster is secured to the smartphone. When the battery booster is secured to the smartphone and the connector connected to the battery charging interface on the smartphone, the battery booster charges the smartphone battery until the smartphone battery is fully charged or until the battery booster battery is drained. In a further embodiment, the smartphone battery and the battery booster battery are both charged when the smartphone charging cable is plugged into the battery booster and the battery booster is connected to the smartphone.

It is an object of the present invention to provide a battery booster for smartphones, tablets and other portable electronic devices which has all the advantages of the prior art devices and none of the disadvantages.

It is another object of the present invention to provide a battery booster that can be removably secured to the portable electronic device.

It is still a further object of the present invention to provide such a battery booster that includes a cable for connection to the electronic device that can be retracted into the body of the battery booster so that the battery booster is available for use at all times and the exposed cable length is minimized.

It is also an object of the present invention to provide such a battery booster that can be recharged simultaneously with the electronic device battery with a single power cord.

It is yet another object of the present invention to provide such a battery booster that includes a universal connector that can be used to charge many smartphones from many different manufacturers.

It is a further object of the present invention to provide such a battery booster that includes a built-in stand to allow the user to stand the electronic device on a table or other surface for hands-free viewing.

These and other objects and advantages of the present invention will become more readily apparent in the description which follows.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an exemplary embodiment that is presently preferred, it being understood however, that the invention is not limited to the specific methods and instrumentality's disclosed. Additionally, like reference numerals represent like items throughout the drawings. In the drawings:

FIG. 1 is a side perspective view of a battery booster, in accordance with one particular embodiment of the present invention, attached to a smartphone.

FIG. 2 is a rear and side perspective view of the battery booster attached to a smartphone of FIG. 1.

FIG. 3A is an isometric view of the battery booster in accordance with one embodiment of the present invention attached a smartphone having a micro USB connection at the top.

FIG. 3B is an exploded, isometric view of the battery booster and smartphone of FIG. 3A.

FIG. 4 is an isometric view of the battery booster in accordance with one embodiment of the present invention attached to a smartphone having a micro USB connection at the bottom.

FIG. 4B is an exploded, isometric view of the battery booster and smartphone of FIG. 4A.

FIG. 5A is an isometric view of a portion of one embodiment of a battery booster of the present invention including a retractable cable mechanism.

FIG. 5B is an isometric view, taken from the front, of the retractable cable mechanism, cable and connector of the battery booster of FIG. 5A.

FIG. 5C is a top plan view of the retractable cable mechanism, cable and connector of the battery booster of FIG. 5B.

FIG. 5D is an exploded isometric view, taken from the rear, of a cable, connector and reel of a retractable cable mechanism according to one particular embodiment of the present invention.

FIG. 5E is an isometric view, taken from the rear, of the retractable cable mechanism, cable and connector of the battery booster of FIG. 5B.

FIG. 5F is an exploded rear plan view of the of a cable, connector and base plate of a retractable cable mechanism according to one particular embodiment of the present invention

FIG. 6A is a front plan view of a battery booster in accordance with one particular embodiment of the present invention.

FIG. 6B is a rear plan view of the battery booster of FIG. 6A.

FIG. 6C is a left side plan view of the battery booster of FIG. 6A.

FIG. 6D is a right side plan view of the battery booster of FIG. 6A.

FIG. 6E is a top plan view of the battery booster of FIG. 6A.

FIG. 6F is a bottom plan view of the battery booster of FIG. 6A.

FIG. 7A is a front perspective view of the battery booster of FIG. 6A.

FIG. 7B is a rear perspective view of the battery booster of FIG. 6A.

### DETAILED DESCRIPTION OF THE PREFERRED EMBODIMENTS

Before explaining the disclosed embodiment of the present invention in detail, it is to be understood that the invention is not limited in its application to the details of the particular arrangement shown since the invention is capable of other embodiments. Also, the terminology used herein is for the purpose of description and not of limitation.

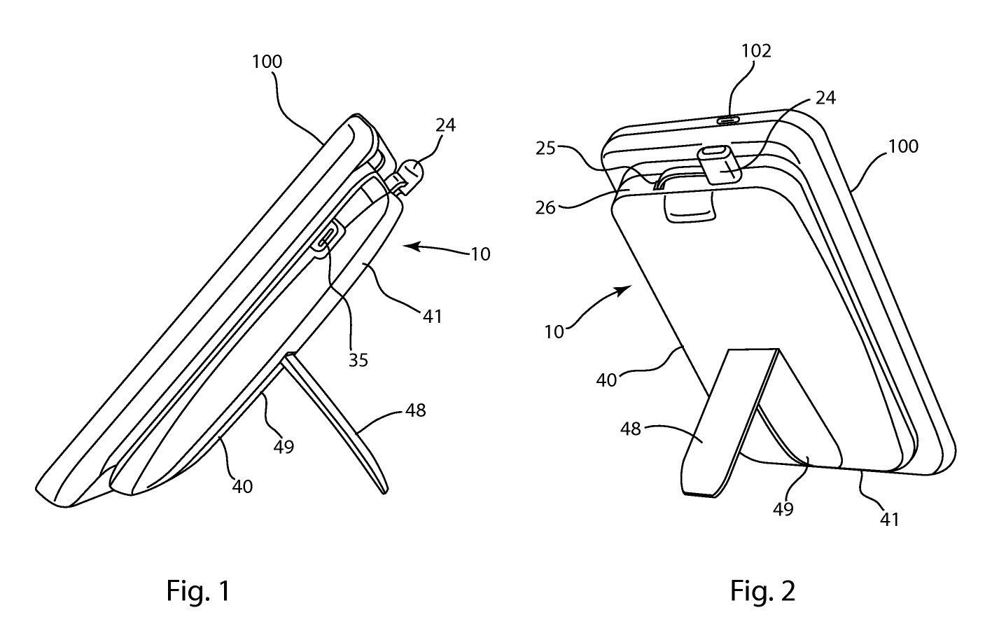

Referring now to FIGS. 1-7B, the present invention is directed to a new and improved battery booster 10 for smartphones, tablets and other portable electronic devices. Although the battery booster 10 of the present invention may be used with smartphones, tablets and other portable electronic devices, for the purpose of illustration, but not limitation, an embodiment for use with a smartphone 100 having its own primary power source (i.e., an internal battery) will be described.

The battery booster 10 includes a battery housing 12 having an interior compartment 14 which holds a battery pack 16 and a retractable cable mechanism 18. In the current preferred embodiment, the battery pack 16 includes at least one battery 13, and a printed circuit board including the circuitry for regulating charging. In one particular embodiment, the battery pack 16 includes a lithium polymer battery and the printed circuit board includes, or provides a base and electrical connection for, three light emitting diodes (“LEDs”) 31, a push button 33 and a micro USB connector 35. Although a lithium polymer battery is used in the current preferred embodiment, it should be appreciated that any rechargeable battery now known or later developed could be used in connection with the present invention.

The battery pack 16 is disposed within the interior compartment 14 so that the LEDs 31 are visible through openings 17 in the side 15 of the battery housing 12. The LEDs 31 are structured to indicate the battery strength, or the charge remaining in the battery 13, in response to the user pressing the push button 33. The number of LEDs 31 that light when the push button 33 is pressed indicates the amount of charge remaining in the battery 13. That is, if all three LEDs 31 light, the battery 13 is near full strength. If only one LED 31 lights, the battery 13 is at low strength. Although the current preferred embodiment uses three LEDs 31, the battery booster 10 could include more or less LEDs to indicate the remaining battery 13 strength or no LEDs. Also, any other means of indicating the strength of the battery 13, now known or later developed, could be used in place of LEDs for this purpose.

The micro USB connector 35 is structured to mate with battery charging cables commonly used with most smartphones today, including house chargers, car chargers and cables for connection to computer USB ports. When the battery charging cable is plugged into the micro USB connector 35 and the respective wall or car electrical outlet or computer, the battery 13 will charge.

The retractable cable mechanism 18 includes a cable 20 and a spring-biased, take-up wheel assembly or wheel 22. One end of the cable 20 is attached to the battery pack 16 inside the battery housing 12 and the opposite end of the cable 20 extends out of the battery housing 12 through an opening 25 in a peripheral wall 26 of the battery housing 12 and is attached to an electrical connector 24 structured to be electrically connected to the battery charging interface or jack 102 on a smartphone 100. The electrical connector or connector 24 is accessible from outside of the housing 24, and thus, may be connected to or disconnected from an interface or jack 102 on a smartphone 100, while the device 10 is secured to the smartphone 100.

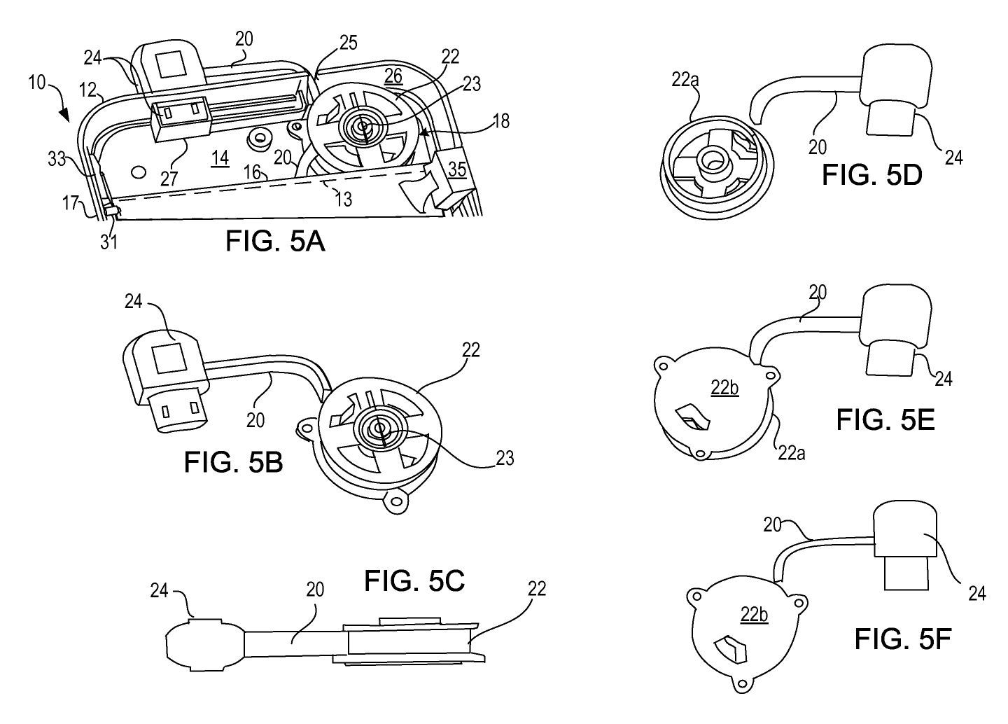

A portion of the cable 20 between the two ends is wrapped around the wheel 22. The wheel 22 is structured and biased to retract a portion of the cable 20 between the wheel 22 and the connector 24 into the battery housing 12 and around the wheel 22. More particularly, the wheel 22 is made up of a reel portion 22a that is spring-biased relative to a base portion 22b, using a torsion spring 23, one leg of which is trapped in a groove in the the top of the reel 22a, as shown in FIGS. 5A and 5B. The base portion 22b is fixed to the interior surface of the cavity 14, permitting the reel 22a to move relative thereto, based on a force on the cable 20, and an opposing force imposed by the torsion spring 23.

Accessible from the outside surface of the peripheral wall 26, adjacent to the opening 25, is a chamber or recessed cavity 27. The recessed cavity 27 is structured to secure the mating end of the connector 24 therein when the connector 24 is not electrically connected to the battery charging interface 102 on the smartphone 100. Securing the connector 24 in the recessed cavity 27 in this manner will protect the contacts on the connector 24 from damage.

Although any type of connector known today or developed in the future may be used, the preferred embodiment described herein uses a micro USB connector since most smartphones today, with the exception of the iPhone, use micro USB connectors as the interface to connect a battery charging cable. It should, however, be appreciated that any other type of connector, including, but not limited to, the proprietary iPhone connector, could be used in place of the micro USB connector, and still be in keeping with the spirit and scope of present invention. Alternately, a universal connector that can be connected to a number of different smartphones can also be used.

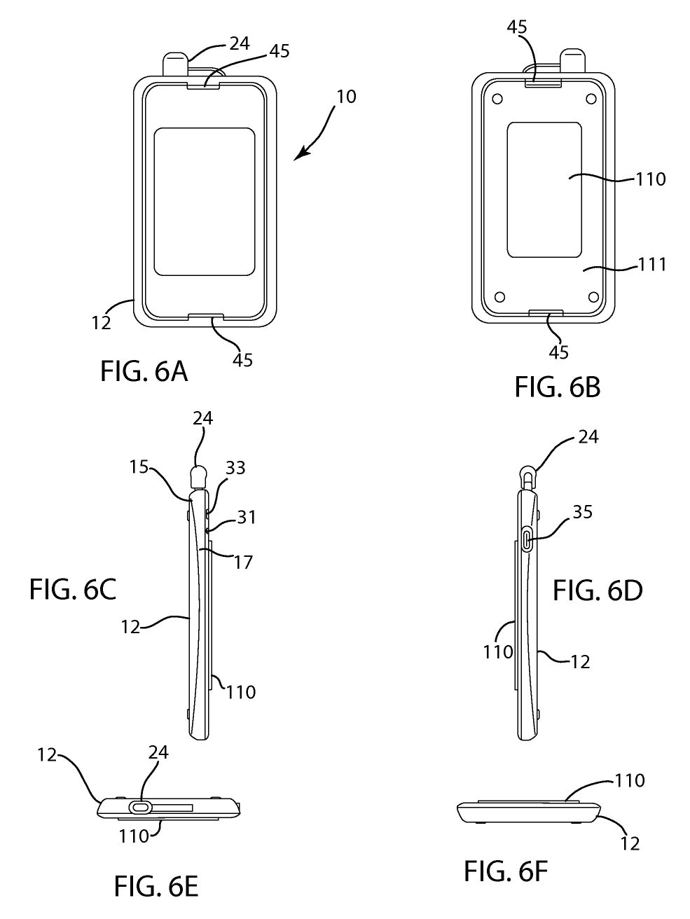

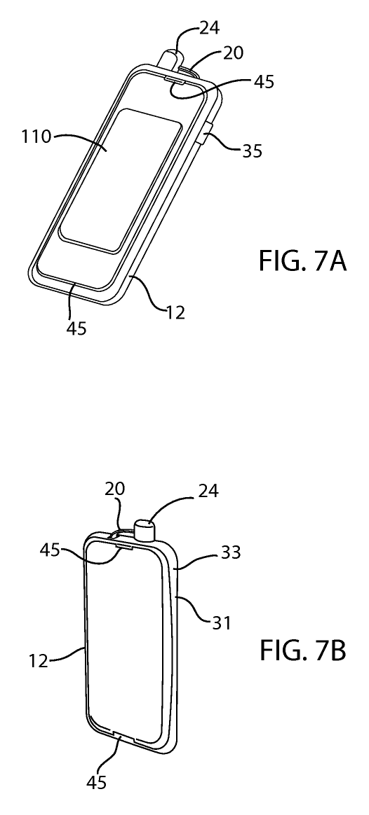

Referring back to FIGS. 1-7B, and in particular, to FIG. 6A-7B, in one particular embodiment of the invention, an adhesive pad 110 is used to removably secure the battery housing 12 to the smartphone 100. In the presently described embodiment of the invention, the battery housing 12 is enclosed on all sides and the adhesive pad 110 is secured to a rear surface 111 of the battery housing 12. In the current preferred embodiment, the adhesive pad 110 is comprised of a polyurethane “sticky pad”, which is capable of adhering to smooth surfaces, retains its sticky properties for extended periods of time and is readily washable and removable with water. Although the embodiment described herein uses a polyurethane “sticky pad” type adhesive to secure the battery housing 12 to the smartphone 100, it should be appreciated that any means of attachment now known or later developed may be used. For example, in one particular embodiment, mating hook and loop fasteners may be used on the rear sides of the battery housing 12 and smartphone 100, in order to reliably connect the two. As a further embodiment, the housing 12 can be made to have a circumferential portion or lip that elastically engages and retains the outer edge of the smartphone 100, thus acting as a further cover for the smartphone 100. The ability to removably secure the battery housing 12 to the smartphone 100 allows the user to carry both the battery booster 10 and smartphone 100 as a single unit, both when the smartphone 100 is being charged and when it is not being charged. Similarly, the ability to detach the battery booster 10 from the smartphone 100 allows the user to carry only the smartphone 100 when desired, and to use the battery booster 10 with more than one smartphone.

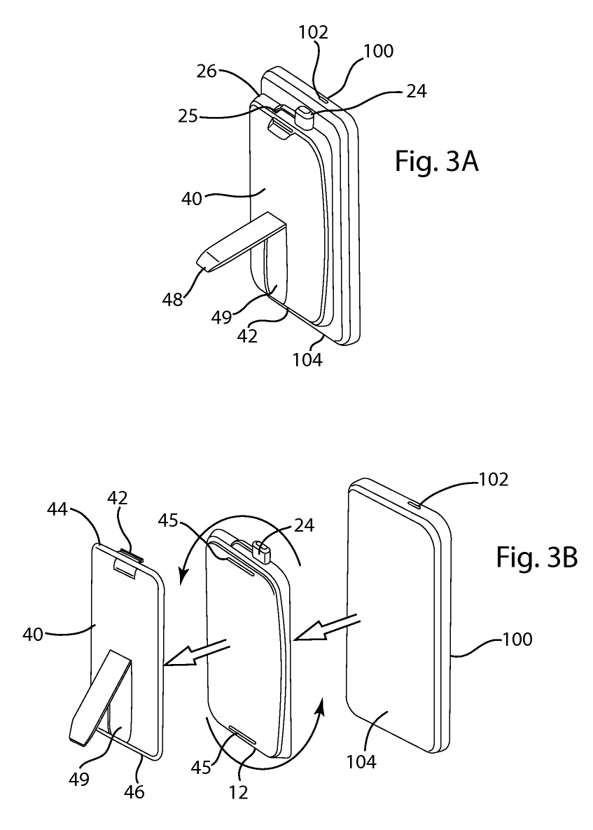

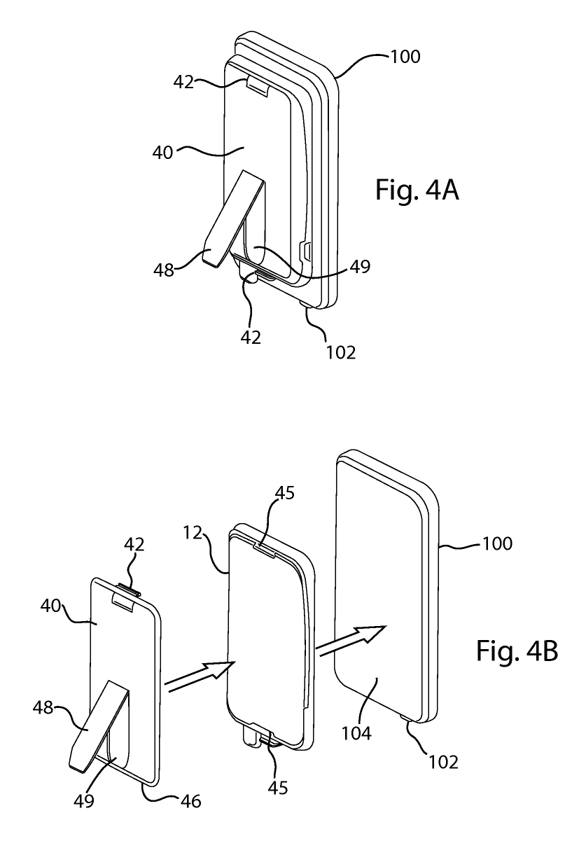

Using the adhesive pad 110, the battery housing 12 is removably secured to the rear outside surface 104 of the smartphone 100. The battery housing 12 may be secured with the connector 24 extending upward if the smartphone 100 battery charging interface 102 is disposed on the top surface of the smartphone 100 (FIGS. 3A, 3B and 6A-7B) or it may be secured with the connector 24 extending downward if the smartphone 100 battery charging interface 102 is disposed on the bottom surface of the smartphone 100 (FIGS. 4A-4B). Additionally, the battery booster 10 may be utilized with smartphones 100 having the battery charging interface 102 on the side edge or any other position on the smartphone 100.

When the battery housing 12 is secured to the smartphone 100, the connector 24 may be removed from cavity 27 and the retractable cable 20 pulled from the opening 25 to the extent necessary to connect the connector 24 to the battery charging interface 102 on the smartphone 100. The retractable cable mechanism 18 ensures that only the length of cable 20 necessary to extend to the battery charging interface 102 on the smartphone 100 is outside of the battery housing 12, as the spring-biased wheel 22 withdraws and winds any excess cable 20 back onto the reel 22A.

In one particular embodiment of the invention shown in FIGS. 3A-4B, a removable or snap-on cover 40 can, optionally, be provided. The removable cover 40 can be used, in a first position (not shown) to cover the adhesive pad 110 when the battery booster 10 is not secured to the smartphone 100. When the cover 40 is secured over the adhesive pad 110, the cover protects the adhesive pad 110 from dirt and damage and prevents the adhesive pad 110 from sticking to any other object.

Additionally, when the battery housing 12 is secured to the smartphone 100, the cover 40 may be used in a second position (shown in FIGS. 3A-4B) wherein the cover 40 is removably secured to the battery housing 12, on the opposite side of the battery housing 12 from the adhesive pad 110, to facilitate gripping of the smartphone 100 and attached battery housing 12. Keeping the cover 40 attached to the battery housing 12 in this manner will also reduce the risk that the cover 40 will be separated, misplaced and not available to cover the adhesive pad 110 when the battery housing 12 is removed from the smartphone 100.

In one preferred embodiment, the cover 40 includes spring clips or tabs 42 projecting forward from the top 44 and/or bottom edges 46 of the cover 40. The tabs 42 are structured to be removably secured to recessed cavities 45 on the upper and lower portions of the front and rear faces of the battery housing 12. In use, the tabs 42 are inserted into the recessed cavities 45 and snapped in place. Although the embodiment disclosed uses snaps to secure the cover 40 to the battery housing, it should be appreciated that the cover 40 may be secured to the battery housing 12 in any other manner now known or later developed.

The cover 40 may also include a swivel leg 48 that can be extended outward and used as a stand for the smartphone 100. The leg 48 is structured to swing from a first secured position wherein the leg 48 is positioned within a recessed cavity 49 in the outer surface 41 of the cover 40 to a second extended position wherein the leg 48 and cover 40 act as a stand to hold the battery booster 10 and attached smartphone 100 in an angled position on a table or other surface for hands-free viewing of the smartphone 100 screen or other hands-free usage of the smartphone 100 by the user. With the leg 48 in the extended position and used as a hands-free stand, the user can position the smartphone 100 either vertically or horizontally to comfortably watch movies or view other content on the smartphone 100 screen. Additionally, the cover 40 may be rotated 180 degrees and mounted to the battery housing 12 with the tab 42 on the top 44 edge of the cover 40 secured to the recessed cavity 45 on the lower portion of the battery housing 12 and the tab 42 on the bottom 46 edge of the cover 40 secured to the recessed cavity 45 on the upper portion of the battery housing 12 to provide alternative viewing angles when the leg 48 is in the extended position.

When the connector 24 on the battery booster 10 is connected to the battery charging interface 102 on the smartphone 100, the battery booster 10 charges the smartphone 100 battery until the smartphone 100 battery is fully charged or until the battery 13 of the battery booster 10 is drained.

With the battery booster 10 of the present invention secured to the smartphone 100 and the connector 24 connected to the battery charging interface 102 on the smartphone 100, the smartphone 100 battery and the battery booster 10 battery 13 can both be charged simultaneously by connecting the smartphone 100 wall electrical charger, car charger or computer cable to the battery booster 100 micro USB connector 35 and plugging such wall charger, car charger or computer cable into the wall or car electrical outlet or computer, as applicable.

It should be appreciated that the battery booster 10 of the present invention may be embodied in a wide range of structures and designs. Additionally, it should be appreciated that the battery booster 10 may be suitable for many different portable electronic devices.

While the invention has been described, disclosed, illustrated and shown in various terms of certain embodiments or modifications, which it has presumed in practice, the scope of the invention is not intended to be, nor should it be deemed to be, limited thereby and such other modifications or embodiments as may be suggested by the teachings herein are particularly reserved, especially as they fall within the breadth and scope of the claims here appended.

I claim:

1. A battery booster for an electronic device, comprising:
a battery housing, including:
a battery pack; and
a take-up wheel;
an electrical connector;
a cable attached at said electrical connector at one end and to said battery pack at a second end; and
a portion of said cable being wrapped around said take-up wheel.

2. The battery booster of claim 1, wherein the electrical connector is configured to mate with a port on the electronic device to provide power from at least one battery of said battery pack to the electronic device and/or to recharge said at least one battery when an outside power supply is connected to the electronic device.

3. The battery booster of claim 1, wherein the take-up wheel is spring-biased in order to wind at least a portion of said cable around said take-up wheel.

4. The battery booster of claim 1, wherein said battery housing is enclosed on all sides with said take-up wheel located on the inside of said battery housing, and a portion of said cable passes through an opening in a wall of said battery housing.

5. The battery booster of claim 4, wherein said battery housing additionally includes a recessed cavity accessible from the outer surface of the battery housing, said recessed cavity being sized to receive and hold a mating portion of said electrical connector when said mating portion of said electrical connector is not mated with an interface of the electronic device.

6. The battery booster of claim 5, wherein said recessed cavity is accessible through one of the top surface and the bottom surface of the battery housing.

7. The battery booster of claim 1, further including a securing mechanism configured to removably secure said battery housing to the electronic device.

8. The battery booster of claim 7, wherein the securing mechanism includes an adhesive pad attached to a first surface of the battery housing.

9. The battery booster of claim 8, further including a removable cover configured to attach to said battery housing in a first position to cover the adhesive pad when the battery booster is not secured to the electronic device, and in a second position to an opposite side of the battery housing.

10. The battery booster of claim 9, wherein said removable cover includes a stand affixed to the rear of the removable cover.

11. The battery booster of claim 10, where the stand can be swiveled relative to the rear of the removable cover.

12. The battery booster of claim 1, wherein the electronic device is a smartphone.

13. A battery booster for an electronic device, comprising:
a battery housing, including a battery pack;
an electrical connector;
a cable attached at said electrical connector at one end and to said battery pack at a second end; and
a securing mechanism on the rear surface of said battery housing to removably secure the battery housing to the electronic device.

14. The battery booster of claim 13, wherein the securing mechanism includes an adhesive pad attached to a first surface of the battery housing; and said battery booster further includes a removable cover configured to attach to said battery housing in a first position to cover the adhesive pad when the battery booster is not secured to the electronic device.

15. The battery booster of claim 14, wherein said removable cover is additionally configured to attach to said battery housing in a second position on the opposite side of said battery housing.

16. The battery booster of claim 15, wherein said removable cover includes a stand affixed to the rear of the removable cover.

17. The battery booster of claim 13, further including a retraction mechanism for retracting at least a portion of said cable within said battery housing.

18. A method for providing auxiliary power to an electronic device, comprising the steps of:
providing a battery booster for an electronic device, including:
a battery housing, including a battery pack and a cable retraction mechanism;
an electrical connector;
a cable attached at said electrical connector at one end and to said battery pack at a second end, at least a portion of said cable engaged with said retraction mechanism; and
a securing mechanism on a rear surface of said battery housing to removably secure the battery housing to the electronic device.
physically securing the battery booster to the electronic device using the securing mechanism;
electrically connecting the battery booster to the electronic device by mating the connector with an interface on the electronic device, the retracting mechanism retracting any excess cable into the battery housing; and
as a consequence of the electrically connecting step, providing power to the electronic device from the battery pack.

19. The method of claim 18, further including the step of, as a consequence of the electrically connecting step, recharging the battery pack of the battery booster when the electronic device is connected to a power supply external to the battery booster and electronic device.

20. The method of claim 18, wherein the securing mechanism is an adhesive pad and the battery booster further includes a removable cover configured to attach to said battery housing in a first position to cover the adhesive pad when the battery booster is not secured to the electronic device.
